(19) United States
(12) Patent Application Publication
(10) Pub. No.: US 2008/0066586 A1
(43) Pub. Date: Mar. 20, 2008

(54) Multi-axis adjustable wrench

(76) Inventor: John J. Cosentino, New Kent, VA (US)

Correspondence Address: John Cosentino, 6768 Poplar Woods CT., Quinton, VA, 23141, US

(21) Appl. No.: 11/521,143

(22) Filed: Sep. 15, 2006

(51) Int. Cl. B25B 13/12; B25B 13/16

(52) U.S. Cl. 81/165; 81/126; 81/128

(57) ABSTRACT

An open ended adjustable clamping device useful as a wrench comprised of a supported jaw movably attached to a supporting jaw. Attached to one or both jaws is an additional sliding jaw movable along a separate axis and driven either simultaneously in a synchronized relationship with the movement of the supported jaw or by a separate unsynchronized movement in order to close upon a hexagonal fastener from two axes. Each jaw has two clamping faces configured to match two sides of a hexagon. Each jaw is positioned in relationship to one another in order to form a hexagon. The two axis movement is driven by a single application of force by the user and may transmitted from one jaw to the next by a system of ramps and wedges or other transmission means capable of maintaining the correct ratio of movement so as to maintain the geometric relationship of the jaws. Alternatively the user applied force may be used to cause movement along one axis first, and then redirected to mobilize jaws along a second axis. When outwardly extended, the jaws could separate sufficiently to pass over a fastener or attached apparatus before being retracted to clamp on the intended fastener. The two-axis movement allows a hexagonal object to be clamped from all sides with sufficient force, surface contact and geometric completeness to allow its safe and effective manipulation.

### CROSS-REFERENCE TO RELATED APPLICATIONS

Not applicable.

### BACKGROUND

1. Field of Invention

This invention relates to wrenches which adjust to fit many different sized fasteners, specifically to an open ended wrench that can be adjusted to grip and apply pressure simultaneously to all sides of many different sized fasteners and is actuated by a single movement.

2. Description of Prior Art

Adjustable wrenches have long been in use in many arenas. Their usefulness is evident by their popularity. A single wrench that is adjustable to accommodate a variety of different size fasteners is a desirable tool. There are, however, distinct disadvantages to the common adjustable wrench. The major disadvantage of the typical prior art adjustable wrench is that it grips a six-sided fastener on only two sides. The result of this minimal contact is that the amount of torque needed to tighten and loosen the fastener is being applied to only two sides of the fastener when the fastener was designed to receive the torque equally distributed over all six sides and is especially evident when applied to hydraulic line fittings. This results in a damaged and distorted fastener which may now be imposable to use. The inevitable slip due to the poor grip on the fastener can sometimes even be responsible for causing injury to the user. Most often, this wrench will simply fail to remove or install the fastener.

Many attempts to improve on the common adjustable wrench have been made. U.S. Pat. No. 5,305,667 to Caballero offers a modified jaw to create a partial contact on four sides of a hexagonal fastener. U.S. Pat. No. 4,838,132 to Pyles describes many adjustable wrench designs, some of which have an open end and others which do not. None of the described inventions grip a hexagonal fastener on more than four sides. All such designs therefore continue to suffer the aforementioned faults.

Another example of an infinitely adjustable wrench is the Bionic Wrench TM. U.S. Pat. No. 6,889,579 to Brown sold by Loggerhead Tools LLC, Palos Park Ill. This tool grips a hexagonal fastener from all six sides in a single coordinated multi-axis movement. An evident problem with the design is that it has no opening by which it can pass over a fastener, screw, hydraulic line or other apparatus and then close over it. This limits its use to fasteners that are not only fully exposed on all sides but also from the top. It also has limited travel and can span only a small range of fastener sizes. If the tool is configured for greater travel, it must trade the travel for gripping power and thereby suffers a reduction in usefulness.

From the above discussion, it can be seen that an adjustable wrench is a desirable tool, but there exists a clear need for one which is open ended so that it can pass over a fastener or other apparatus and then close upon the fastener so as to apply sufficient force over a large contact area and to manipulate the fastener effectively.

### SUMMARY

This wrench described herein can be opened to pass over a hexagonal fastener or other apparatus and then close upon it. It is adjustable so as to accommodate all sizes of fasteners within its size range, both metric and SAE. A single adjustment by the user will cause either a synchronized or unsynchronized movement resulting in more than four sides of a fastener being simultaneously griped by two main jaws and one or more additional sliding jaws.

### Objects and Advantages

Accordingly, there remains a need for a wrench that adjusts to many sizes of fastener and grips them securely, evenly distributing the wrenching force applied by the user so that the fastener is not damaged and the wrench does not slip. This can best be accomplished by a tool that can open to pass over a hexagonal fastener and then close upon it gripping all sides of the fastener simultaneously.

The several objects and advantages of the present invention are:
To provide an adjustable wrench that can accommodate a wide range of fastener sizes, both metric and S.A.E.;
To provide an adjustable wrench that distributes the wrenching load over all the surfaces of a fastener;
To provide an adjustable wrench that is easy to use and the function of which is easily recognizable to the user;
To provide an adjustable wrench that opens so it can pass over a fastener or other apparatus and can therefore function well as a hydraulic line wrench;
To provide an adjustable wrench that utilizes a simple design to minimize costs of manufacture and assembly;

### Still further objects and advantages of the present invention will become apparent from a consideration of the ensuing drawings and description.

### DRAWING FIGURES

FIG. 1 shows the preferred embodiment with the bottom jaw in section to reveal the inner workings of the device and the opening whereby the wrench can be adjusted to pass over a fastener.

FIG. 2-A shows the two jaws overlapped in a typical functioning position for a larger fastener.

FIG. 2-B shows the two jaws overlapped in a typical functioning position for a smaller fastener.

FIG. 3 shows only one jaw with the moving inner parts drawn in a maximum size position, and then outlined in their minimum size position in order to clearly display the relative movements.

FIG. 4 shows a section view of the jaws without the internal parts installed, revealing the grooved tongue system of holding the jaws together in a movable manner.

FIG. 5 shows an additional embodiment as the invention is applied to a pair of pliers.

FIG. 6 shows an alternative embodiment of the adjusting mechanism demonstrating a quick-adjusting mechanism.

### REFERENCE NUMERALS IN DRAWINGS

| | |
|---|---|
| 10 | top jaw |
| 11 | sliding surface |
| 12 | sliding jaw |
| 13 | grooved tongue |
| 14 | adjusting wedge |
| 16 | drive block |
| 17 | set screw |
| 18 | slide face |
| 19 | spring |
| 20 | bottom jaw |
| 21 | sliding surface |
| 22 | sliding jaw |
| 23 | grooved tongue |
| 24 | adjusting wedge |
| 26 | drive block |
| 27 | set screw |
| 28 | drive face |
| 29 | spring |
| 30 | adjusting screw |
| 31 | support base |
| 32 | traveler wedge |
| 33 | angled pressure face |
| 34 | adjusting wheel |
| 36 | key |
| 39 | lift spring |
| 41 | half-nut pin |
| 43 | resistance spring |
| 45 | pivot |

### DESCRIPTION

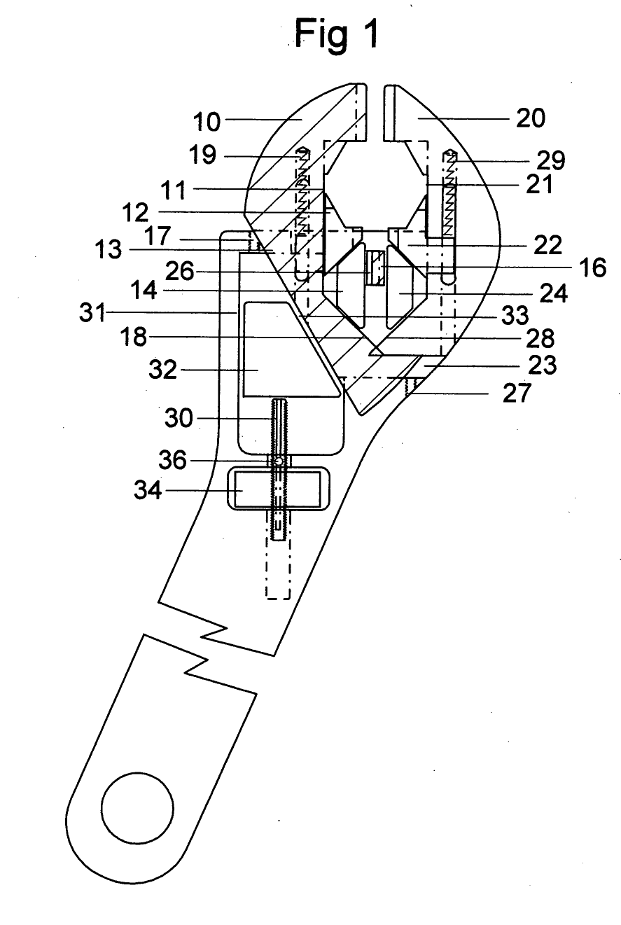

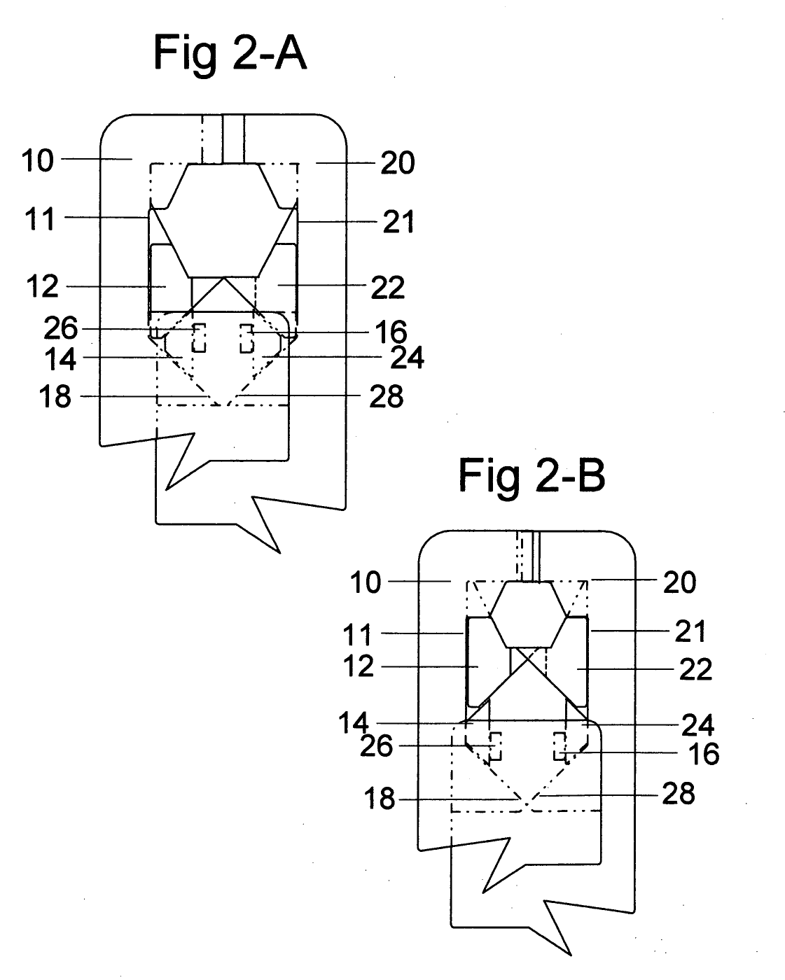

### FIGS. 1, 2-A, 2-B, 3 and 4—Preferred Embodiment

In its preferred embodiment, FIG. 1 shows a wrench comprised of a top jaw (20) which is the support structure of the device, and a supported structure called a bottom jaw (10). Top jaw (20) and bottom jaw (10) may be symmetrical and overlay one another. FIG. 4 illustrates a grooved tongue (13 & 23) on each jaw (10 & 20) that interlocks the opposing jaw (10 & 20) in a parallel yet mobile relationship to one another. A set screw (17 & 27) holds each jaw (10 & 20) to the other by passing perpendicularly through jaw (10 & 20) and riding in the side of grooved tongue (13 & 23).

In FIG. 1, top jaw (20) and bottom jaw (10) are each designed to form two sides of a hexagon within their inner tips. The hexagon is positioned so that one of its sides is parallel to the axis of movement of bottom jaw (10). The forward most section of top jaw (20) and bottom jaw (10) may overlap so that together they form and complete the same side of the hexagon. Top jaw (20) and bottom jaw (10) fit and combine so as to create three sides of a hexagon, the size of which varies according to their position.

FIGS. 2-A and 2-B best illustrate that jaw (10 & 20) is designed with a sliding surface (11 & 21) leading up to the hexagonal pocket. Sliding surface (11 & 21) is to support a sliding structure called a sliding jaw (12 & 22). Sliding jaw (12 & 22) is designed to form two sides of a hexagon. When fitted into top jaw (20) or bottom jaw (10), sliding jaw (12 & 22) rides on sliding surface (11 & 21) and can travel forward and back.

When positioned in jaw (10 & 20), the rear most section of any two sliding jaw (12 & 22) may overlap so that together they form and complete the same side of a hexagon. A pair of sliding jaw (12 & 22) fit and combine so as to create the other three sides of a hexagon, the dimensions of which varies according to their position.

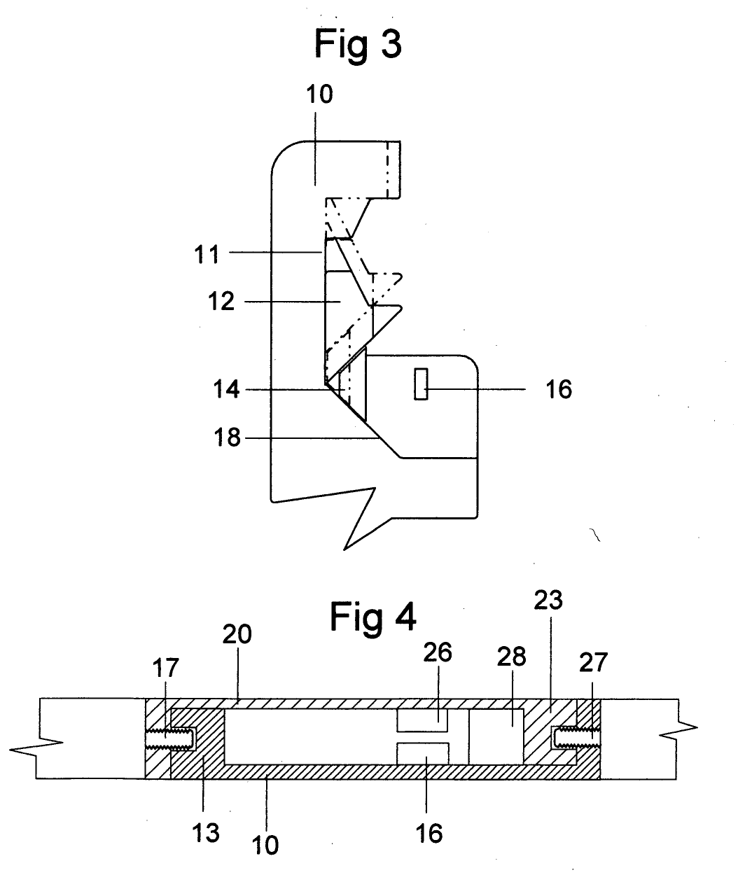

FIG. 3 shows just one jaw with the other removed. This illustrates that behind sliding jaw (12 & 22) rests a adjusting wedge (14 & 24). Adjusting wedge (14 & 24) is designed to drive sliding jaw (12 & 22) at the correct ratio in relation to the movement of top jaw (20) and bottom jaw (10). The movement of bottom jaw (20) in relation to top jaw (10) is redirected to sliding jaw (12 & 22) by a conveyance means utilizing drive block (16 & 26). Drive block (16 & 26) redirects the forces applied to cause movement in a second axis of travel by acting on adjusting wedge (14 & 24). In the preferred embodiment, adjusting wedge (14 & 24) rides against a drive face (18 & 28) which may be positioned at a predetermined angle and located in both top jaw (20) and bottom jaw (10) in order to act as a ramp. The back face of sliding jaw (12 & 22) is at a predetermined angle and rides against a matching predetermined angled face on adjusting wedge (14 & 24). The combination of these matched predetermined angles provides the correct ratio to maintain the geometrical relationship between the movement of sliding jaw (12 & 22) and jaw (10 & 20). In the preferred embodiment, this ratio would be 1.157:1. This transmission means maintains the geometric relationship of the clamping surfaces during movement in multiple axes. When the clamping configuration forms a true hexagonal pocket at any one position, the pocket will retain its hexagonal relationship throughout the travel range of the mechanism.

FIG. 1 shows a spring (19 & 29). As sliding jaw (12 & 22) move forward, it compress spring (19 & 29). The function of spring (19 & 29) is to push sliding jaw (12 & 22) back when bottom jaw (10) is retracted.

The assembly can be activated by many different driving means. In the preferred embodiment shown in FIG. 1, top jaw (20) is designed with a base support (31) which supports a traveler wedge (32). Traveler wedge (32) is a right triangle, the hypotenuse of which rides against a angled pressure face (33) located on bottom jaw (10) which acts as a ramp for it. An adjusting screw (30) is mounted in top jaw (20). A keyway cut along its length allows adjusting screw (30) to travel forward and back, but prevents its rotation by means a key (36) located in top jaw (20). Adjusting screw (30) is threaded on one end and passes through a adjusting wheel (34). Adjusting wheel (34) is threaded internally to match adjusting screw (30) and is itself fitted into a pocket in top jaw (20).

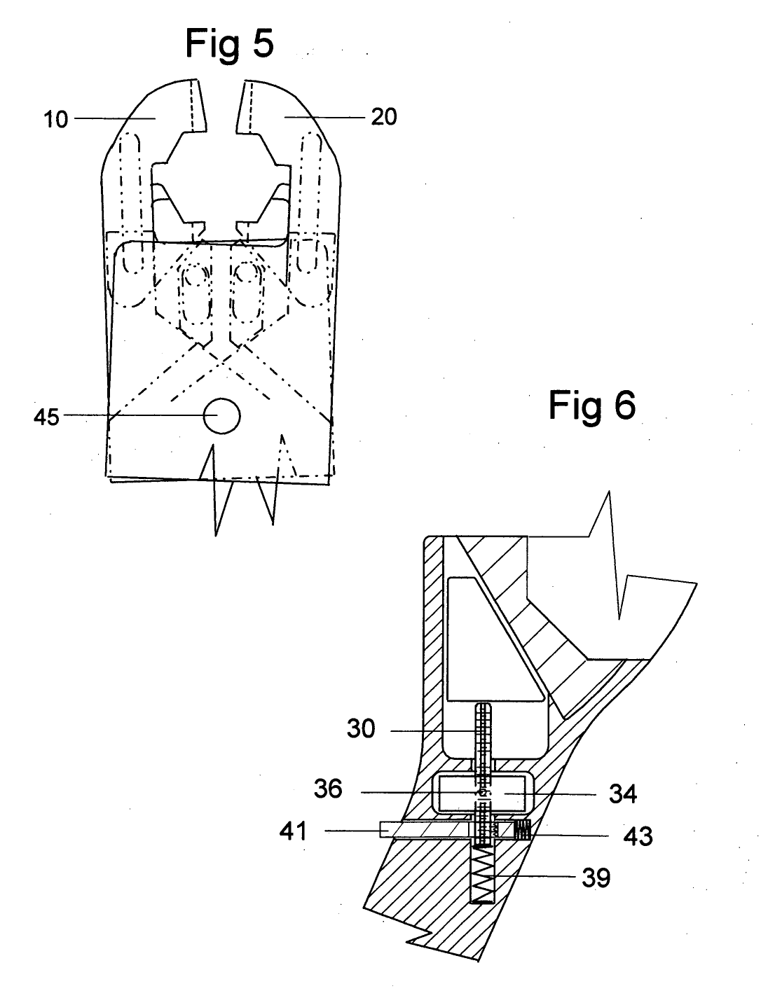

### FIG. 5-Alternative Embodiment—Pliers

Many alternative embodiments are possible using this technology. For example, FIG. 5 illustrates how by changing the ratio which drives sliding jaws (12 & 22), and having jaws (10 & 20) joined at a pivot point (45) the tool can be designed to function as a pair of pliers, or even locking pliers (i.e. a Vice Grip TM).

### FIGS. 6—Quick-Adjusting Mechanism

The above described device can also be more quickly adjusted to size by adding a quick-adjusting mechanism. FIG. 6 shows an example of how this could be done. By attaching adjusting wheel (34) to adjusting screw (30) with key (36), adjusting wheel (34) can be used to rotate adjusting screw (30) against a half-nut pin (41). Adjusting screw (30) can then be released from its position by sliding half-nut pin (41) up with finger pressure, compressing a resistance spring (43) and thereby releasing adjusting screw (30). This will allow bottom jaw (10) to travel down freely with hand pressure and be gently driven up by a lift spring (39). The device can now be quickly swept open so as to pass over or onto on a chosen hexagon and then closed on it. Half-nut pin (41) can then be reengaged with adjusting screw (30) by releasing finger pressure and allowing resistance spring (43) to drive it in place. Adjusting wheel (34) can then be used only to make fine adjustments, or make the final tightening of the device around the chosen hexagon.

### Additional Embodiments

This technology can also be used in conjunction with pockets of other geometric shapes comprised of more than two sides, including, but not restricted to, three and four sided shapes.

The adjustable clamping device can be used as a hydraulic line wrench. By leaving the amount that the jaws (10 & 20) overlap at their tip incomplete, jaws (10 &20) can pass over a hydraulic line when adjusted to be open. It can then be adjusted to close on all sides of the fastener.

Additionally, this adjustable clamping device can be incorporated into the form of locking pliers which allows quick adjustment and substantial closing force to be applied to the device.

This same technology could be utilized using fewer parts. For example, by combining the pocket geometry of a pair of sliding jaws (12 & 22) into one jaw and omitting the side of the hexagon which is parallel to the travel of jaw (10 & 20) from the pocket geometry on sliding jaw (12 & 22), one sliding jaw (12) may be eliminated. By then angling slide surface (21) down at an 11 degree angle to act as a ramp and adjusting the ratio of movement of sliding jaw (22) to 2.66:1, sliding jaw (22) will remain centered to the hexagonal form as it travels. This simplification will create a device able to clamp a hexagon from five of its six sides.

Alternatively, the two-axis movement need not be synchronized. When incorporated into a pair of pliers for example, the device can be designed to have a lever overlapping one handle of the pliers. When the handles and lever are squeezed, the lever action causes bottom jaw (10) to close on top jaw (20). Once jaw (10 & 20) has encountered the intended sides of a hexagonal fastener, the resistance would prevent the continued movement of the lever and the pressure would then be applied to the movement of the pliers handles. This would redirect pressure to drive sliding jaw (12 & 22) against their respective intended sides of a hexagonal fastener. At this point a hexagonal fastener would be gripped from all sides and could be driven by maintaining pressure on the handles while applying a wrenching force to the pliers.

Other methods of driving sliding jaw (12 & 24) can be implemented. Some of these may include, but are not restricted to:

### Cam action;

### Gear drive;

### Screw;

### Lever.

This technology can clearly by utilized in many ways to numerous to outline in detail at this time, however the geometric shape of the pocket and the method of accomplishing two axis movement, whether simultaneous or sequential, synchronized or unsynchronized, as well as the number of contact surfaces is immaterial and should not be construed as a novel advancement over the original technology described herein.

### Advantages

From the description given above, a number of advantages of my adjustable wrench become evident:
1 A hexagonal fastener can be gripped on all sides, distributing the driving force evenly on all surfaces. As a result it is:
   More likely to effectively drive the fastener, thereby resulting in a satisfied user.
   Less likely to slip and cause injury to the user making it a safer tool to use;
   Less likely to damage the fastener, thereby extending the fasteners useful life and aesthetic qualities.
2 It use is easy to understand and it is similar in function to that of common adjustable wrenches thereby making it easily accepted and utilized by it's prospective users.
3 It can be opened to pass over a hydraulic line or other apparatus and then be closed on all sides of a variety of sizes of fastener making it useful as an adjustable line wrench, adjustable pipe wrench, adjustable tie rod wrench, etc.
4 It can be manufactured as a tool with synchronized movement or a less precise, and therefore less expensive, unsynchronized movement.
5 It has few parts and is of simple design so as to be inexpensive to manufacture.
6 The design can be incorporated into several different styles of tools, potentially making it a candidate for a line of tools with special market appeal.

### Operation—FIGS. 1-4

In the preferred embodiment, as adjusting wheel (34) is rotated, adjusting screw (30) pushes against traveler wedge (32) and drives it forward. In so doing, it separates angled pressure face (33) from base support (31). This causes bottom jaw (10) to be driven against top jaw (20) and causes jaws (10 & 20) to close in relation to one other. As a result, drive block (16 & 26) push the adjusting wedge (14 & 24) between drive face (18 & 28) and sliding jaw (12 & 22). This drives sliding jaw (12 & 22) forward along sliding surface (11 & 21) toward the opposing side of the hexagonal pocket while compressing spring (19 & 29). All this occurs in one synchronized two-axis movement. The result is that a hexagonal pocket formed by the combined components becomes smaller while retaining its hexagonal geometry.

As adjusting wheel (34) is turned in the opposite direction, adjusting screw (30) is retracted. Spring (19 & 29) pushes sliding jaw (12 & 22) back. Sliding jaw (12 & 22) applies pressure to adjusting wedge (14 & 24). Adjusting wedge (14 & 24) in turn push back against drive block (16 & 26) causing a separation between top jaw (20) and bottom jaw (10). As a result, the hexagonal pocket created by the mechanism gets larger while retaining its hexagonal geometry.

When the hexagonal pocket is of the correct size to match the hexagonal fastener to be driven, torque may then be applied to the device and a fastener can be safely tightened or loosened.

### CONCLUSION, RAMIFICATIONS, AND SCOPE

The reader will see that utilizing this adjustable clamping device as an adjustable wrench is a simple, easy to use tool that will offer reliable function and low maintenance. It is also a low cost tool design, easily incorporated into many standard tool styles. The design can be enlarged or miniaturized to accommodate different ranges of fastener sizes. Since this clamping device is infinitely variable in movement within its size range, it can accommodate both S.A.E. and metric fasteners equally as well.

The adjustable clamping device's two-axis movement can be synchronized as previously described or unsynchronized. An example of unsynchronized movement would be to incorporate a system by which squeezing a pair of levers could be used to first drive the jaws together, and once resistance is encountered, the force would be redirected to drive the sliding jaws against the fastener.

The pocket area of the adjustable clamping device can be of geometric shapes other than a hexagon. For example, if manufactured with a square pocket area, it can be used on square nuts, or it can function as an adjustable holder for taping tools which have square drive shanks.

The adjustable clamping device can also be used for other functions besides to drive a fastener. For example it can be used as an adjustable centering guide on a bar feed machine tool.

Although the description above contains many specificities, these should not be construed as limiting the scope of the invention but as merely providing illustrations of some of the presently preferred embodiments of this invention. For example, a variety of methods can be utilized to accomplish the two-axis movement making the adjustable clamping device more versatile. One example of this is that the tapered wedges can be replaced with a cam system. Likewise, connecting rods or link pins or a system of gears can be utilized. Alternatively, especially in the case of shapes with four or fewer sides, the clamping device could be built with only one sliding jaw which spans both of the jaws.

These and many other forms and functions of the invention are possible. Thus the scope of the invention should be determined by he appended claims and their legal equivalents, rather than by the examples given.

1. I claim an adjustable clamping means comprised of:
a) a support structure capable of being mounted to an apparatus or driven with a required force to accomplish a desired purpose, having a pocket capable of receiving within itself a portion of a predetermined geometric shape and at least one surface capable of supporting a movable supported structure and;
b) a supported structure having a pocket capable of receiving within itself a portion of a predetermined geometric shape, it being movably attached to said support structure and so positioned as to allow said pocket to relate to that of said support structure and;
c) at least one sliding structure, having a pocket capable of receiving within itself a portion of said predetermined geometric shape, being movably attached to said support structure or said supported structure and so positioned as to allow said pocket to relate to that of one or both of said support structure and said supported structure and;
d) at least one driving means capable of generating sufficient force to urge said supported means against said support means and said sliding means against at least one of said support means or said supported means either simultaneously or sequentially.

2. The adjustable clamping means described in claim 1 wherein said sliding structure is being urged through the interference of a conveyance means attached to said support structure or said supported structure, said conveyance means being capable of redirecting the force applied by said driving means to said support structure and said supported structure onward to said sliding means.

3. The conveyance means stated in claim 2 in which said necessary force and said predetermined ratio are transmitted by an arrangement of ramps and wedges.

4. The conveyance means stated in claim 2 in which the necessary force and ratio are maintained by an arrangement of one or more cams and followers.

5. The conveyance means stated in claim 2 in which the necessary force and ratio are maintained by the movement of a lever arrangement.

6. The conveyance means stated in claim 2 in which the necessary force and ratio are maintained by an arrangement of one or more gears.

7. The adjustable clamping means described in claim 1 wherein said supported structure has means of generating sufficient range of motion to permit its being drawn away from said support structure to allow said pockets of each to pass over the intended said predetermined geometric shape or other apparatus.

8. I claim an adjustable clamping means comprised of:
a) a support structure capable of being mounted to an apparatus or driven with the needed force to accomplish a desired purpose, having a pocket capable of receiving within itself a portion of a predetermined geometric shape and at least one surface capable of supporting a movable supported structure and;
b) a supported structure having a pocket capable of receiving within itself a portion of a predetermined geometric shape, it being movably attached to said support structure and so positioned as to allow its portion of said predetermined geometric shape to relate to that of said support structure and;
c) at least one of a sliding structure, having a pocket capable of receiving within itself a portion of said predetermined geometric shape, being movably attached to said support structure or said supported structure and so positioned as to allow its portion of said predetermined geometric shape to relate to that of one or both of said support structure and said supported structure and;
d) at least one driving means capable of generating sufficient force to urge said supported structure against said support structure and said sliding structure against at least one of said support structure and said supported structure and;
e) a transmission means capable of transmitting the movement of said driving means to said sliding structure with sufficient force to urge said sliding structure along a predetermined path at a predetermined ratio of movement sufficient to maintain a predetermined geometric relationship between said sliding structure, said support structure and said supported structure whereby once adjusted to accommodate said predetermined geometric shape, said needed force, when applied to said support structure, will be transmitted from a plurality of directions to said predetermined geometric shape.

9. The transmission means described in claim 8 wherein said sliding structure is being urged through the interference of a conveyance means attached to said support structure and said supported structure, said conveyance means being capable of redirecting said necessary force applied to said support structure and said supported structure onward to said sliding means.

10. The adjustable clamping means described in claim 8 wherein said pocket attached to said support means and said supported means have means to enable their being drawn away from each other sufficiently to allow said pocket to pass over the intended said predetermined geometric shape or other apparatus.

11. The transmission means described in claim 9 in which said necessary force and said predetermined ratio are transmitted by means of an arrangement of ramps and wedges.

12. The transmission means described in claim 9 in which said necessary force and said predetermined ratio are transmitted by means of an arrangement of one or more cams and followers.

13. The transmission means described in claim 9 in which said necessary force and said predetermined ratio are transmitted by means of a lever arrangement.

14. The transmission means described in claim 9 in which said necessary force and said predetermined ratio are transmitted by means of an arrangement of one or more gears.

15. The transmission means described in claim 9 in which said necessary force and said predetermined ratio are transmitted by means of an arrangement of one or more screws.

16. I claim a method of rotating a hexagonal fastener comprised of:
a) a supporting structure capable of bearing a load, having a pocket in the shape of a portion of a hexagon;
b) a supported structure movably attached to said support structure having a pocket in the shape of a portion of a hexagon;
c) one or more sliding structures movably attached to one or both of said supported structure and said supporting structure, said sliding structure having a pocket in the shape of a portion of a hexagon;
d) one or more of a driving structure capable of urging said supported structure against said supporting structure and one or more of said sliding structure against one or both of said supporting structure and said supported structure whereby when driven together, said portions of said pocket shall close upon an intended hexagonal fastener with sufficient geometric completeness, surface contact and force to distribute said load applied to said supporting structure to a plurality of locations on said hexagonal fastener resulting in its rotation.

17. The method of rotating a hexagonal fastener described in claim 16 wherein said pocket attached to both said supporting structure and said supported structure have means to enable their being drawn away from each other sufficiently to allow said pocket to pass over said hexagonal fastener or other apparatus before closing upon it.

18. The driving structure described in claim 16 wherein said sliding structure is being urged through the interference of a conveyance means attached to said supporting structure or said supported structure, said conveyance means being capable of redirecting the load applied to said supporting structure and said supported structure by said driving structure onward to said sliding structure.

19. The conveyance means stated in claim 18 in which the necessary force and ratio are transmitted by an arrangement of ramps and wedges.

20. The conveyance means stated in claim 18 in which the necessary force and ratio are transmitted by means of one or more cams and followers.
